(19) United States
(12) Patent Application Publication
(10) Pub. No.: US 2022/0020522 A1
(43) Pub. Date: Jan. 20, 2022

(54) CORE FOR TORQUE DETECTION SENSOR AND TORQUE DETECTION SENSOR

(71) Applicant: SHINANO KENSHI KABUSHIKI KAISHA, Nagano (JP)

(72) Inventor: Akihide FURUKAWA, Nagano (JP)

(21) Appl. No.: 17/340,265

(22) Filed: Jun. 7, 2021

(30) Foreign Application Priority Data
Jul. 17, 2020 (JP) 2020-122676

(51) Int. Cl. H01F 27/245; G01L 3/10; H01F 27/26

(52) U.S. Cl. CPC H01F 27/2455; H01F 27/266; G01L 3/102

(57) ABSTRACT

A core for a torque detection sensor includes a first laminated core in which first teeth are provided to protrude in a radial direction at plural places from an annular first core back formed by laminating a plurality of magnetic sheet materials, and a second laminated core in which second teeth are provided to protrude in the radial direction at plural places from an annular second core back formed by laminating a plurality of magnetic sheet materials, in which the first laminated core and the second laminated core are stacked so that the first teeth and the second teeth are in staggered arrangement in a circumferential direction.

### CROSS-REFERENCE TO RELATED APPLICATION

This application is based upon and claims the benefit of priority of the prior Japanese Patent Application No. 2020-122676, filed on Jul. 17, 2020, and the entire contents of which are incorporated herein by reference.

### TECHNICAL FIELD

The present invention relates to a core for a torque detection sensor and a self-excitation torque detection sensor.

### BACKGROUND ART

There exists a magnetostrictive torque detection device as a method for detecting the torque acting on an object to be detected such as a rotary shaft by a non-contact manner. For example, surface treatment (for example, plating, grooving, or the like) for increasing magnetostrictive characteristics is performed on the surface of a shaft to be detected distortion of which is detected, and magnetostrictive effect is measured to detect the torque. The measurement of the magnetostrictive effect is executed by arranging coils coaxially wound around the shaft and reading variation in magnetic permeability of the shaft generated by Villari effect based on the magnitude of impedance.

As the torque detection device, the applicant has proposed a magnetostrictive torque detection sensor in which magnetic paths formed between the object to be detected and a plurality of cores assembled to insulation cylindrical bodies so that the magnetic paths formed at the object to be detected have a prescribed angle with respect to its axis center are respectively increased to thereby improve torque detection sensitivity. The plural cores are disposed in an inclined manner at a prescribed angle with respect to an axial center direction of the object to be detected so that end faces of both side leg portions face the object to be detected from inner circumferential surfaces of the insulation cylindrical bodies. As the cores formed in a U-shape are disposed in the inclined manner at the prescribed angle with respect to the axial center of the object to be detected, an independent magnetic path passing one leg portion (end surface), the object to be detected, the other leg portion (end surface), and a bridge portion is formed. As described above, the same magnetic field is generated around a coil as the same coil passes through the plural cores, which forms the same pole. Accordingly, magnetic fluxes are concentrated to the cores and a magnetic path connecting adjacent cores to each other is not easily formed; therefore, a structure in which detection sensitivity is improved can be obtained (PTL 1: Japanese Patent No. 6483778).

### SUMMARY OF INVENTION

### Technical Problem

However, in the torque detection device of the above patent literature, it is necessary to form grooves on an outer peripheral surface of the insulation cylindrical bodies and to wind the plural detection coils along the grooves, and further, the plural cores are assembled to the insulation cylindrical bodies so that the detection coils pass through a U-shaped space surrounded by the bridge portion connecting the both side leg portions.

Accordingly, it is necessary to embed the detection coils and the cores by utilizing the thickness of the insulation cylindrical bodies in a radial direction; therefore, the sensor tends to be increased in size in the radial direction and an axial direction. As the end faces of both side leg portions forming the cores are provided so as to face the object to be detected, the shape of the end faces has to be, not a flat surface, but an arc-shaped curved surface, which increases processing costs.

There is also a demand that torque is delicately detected over the entire periphery of the object to be detected without reducing detection sensitivity.

### Solution to Problem

In response to the above issue, one or more aspects of the present invention are directed to a core for a self-excitation type torque detection sensor capable of reducing the size of the sensor and being mass produced at low cost, and directed to a small-sized torque detection sensor capable of detecting compressive stress and tensile stress generated over the entire periphery of an object to be detected without reducing detection sensitivity by using the above core.

In view of the above, the following embodiments are described below.

A core for a torque detection sensor measures variation of magnetic permeability by variation of coil impedance in magnetic circuits formed between a core and an object to be detected by energizing coils wound around teeth provided to protrude from the annular core provided around the object to be detected at plural places, which includes a first laminated core in which first teeth are provided to protrude in a radial direction at plural places from an annular first core back formed by laminating a plurality of magnetic sheet materials, and a second laminated core in which second teeth are provided to protrude in the radial direction at plural places from an annular second core back formed by laminating a plurality of magnetic sheet materials, in which the first laminated core and the second laminated core are stacked so that the first teeth and the second teeth are in staggered arrangement in a circumferential direction.

The first laminated core in which the first teeth are provided in the annular first core back and the second laminated core in which the second teeth are provided in the annular second core back can be manufactured through manufacturing processes similar to a laminated core used for a stator core of a motor, and the coils to be wound around the first teeth and the second teeth can be wound by using a winding machine; therefore, the sensor can be reduced in size in the radial direction and an axial direction and can be mass produced at low cost.

It is preferable that the first teeth and the second teeth are provided in staggered arrangement with a phase difference having an inclination of 45 degrees with respect to the circumferential direction.

Accordingly, a plurality of magnetic paths having an inclination of +45 degrees and a plurality of magnetic paths having an inclination of −45 degrees with respect to an axial center direction are respectively formed between the first teeth and the second teeth; therefore, variation of magnetic permeability is measured as variation of coil impedance in the plural magnetic circuits, thereby detecting compressive stress and tensile stress generated over the entire periphery of the object to be detected without reducing detection sensitivity.

It is preferable that magnetic-flux action surfaces of the first teeth and the second teeth which face the object to be detected are formed to be wider in width.

Accordingly, a larger number of magnetic fluxes pass through the object to be detected from respective teeth, which improves detection sensitivity.

The first laminated core and the second laminated core may be stacked through an annular intermediate core formed of magnetic sheet materials.

Accordingly, a larger number of coils can be wound around the first teeth and the second teeth; therefore, an amount of magnetic fluxes acting on the object to be detected is increased to thereby improve detection sensitivity.

It is preferable that an outer diameter of the annular intermediate core formed of the magnetic material is larger than those of the first laminated core and the second laminated core, and that the first laminated core and the second laminated core are concentrically fitted from both end openings of the intermediate core to be integrally assembled.

A larger number of coils can be wound around the first teeth and the second teeth also according the above by providing a distance in the axial center direction between the first core back and the second core back; therefore, the amount of magnetic fluxes acting on the object to be detected is increased to thereby improve detection sensitivity.

It is preferable that the first teeth are assembled so that engaging portions are fitted in the axial center direction into dovetail grooves provided on a peripheral surface of the first core back, and that the second teeth are assembled so that engaging portions are fitted in the axial center direction into dovetail grooves provided on a peripheral surface of the second core back.

Accordingly, the coils can be wound in a state where the first teeth are removed from the first core back and in a state where the second teeth are removed from the second core back; therefore, the winding work becomes easy and productivity can be improved.

It is preferable that the first teeth are assembled so that projections provided on a peripheral surface of the first core back are fitted in the axial center direction into recesses provided at end portions in the radial direction, and that the second teeth are assembled so that projections provided on a peripheral surface of the second core back are fitted in the axial center direction into recesses provided at end portions in the radial direction.

Accordingly, the degree of freedom in assembling the first teeth to the first core back and assembling the second teeth to the second core back is high, which improves productivity.

A torque detection sensor includes the core for the torque detection sensor according to any one of the above, and a plurality of energizing circuits in which first coils and second coils which are wound in different directions around the first teeth and the second teeth are connected in series.

Accordingly, it is possible to delicately detect compressive stress and tensile stress generated over the entire periphery of the object to be detected.

The sensor may be a self-excitation sensor that measures variation of magnetic permeability by variation of coil impedance in magnetic circuits formed between a core and an object to be detected by energizing the first coils wound around the first teeth and the second coils wound around the second teeth provided to protrude in the core for the torque detection sensor in staggered arrangement.

In this case, the compressive stress or tensile stress acting on the object to be detected can be detected by energizing the first coils and the second coils at arbitrary timing.

### Advantageous Effects of Invention

It is possible to provide a core for a self-excitation torque detection sensor capable of reducing the size of the sensor and being mass-produced at low cost.

It is also possible to provide a small-sized toque detection sensor capable of detecting compressive stress and tensile stress generated over the entire periphery of an object to be detected by using the above without reducing detection sensitivity.

### BRIEF DESCRIPTION OF DRAWINGS

FIGS. 1A to 1C are plan views showing states of cores for a torque detection sensor, and a plan view of a torque detection sensor.

FIGS. 2A to 2C are a front view, a plan view, and a perspective view of an exploded torque detection sensor.

FIG. 3 shows a developed view of the core, an explanation view of energizing circuits, an explanation view for magnetic paths formed between teeth.

FIG. 4 is an explanatory view for the magnetic paths formed between the teeth of FIG. 3.

FIGS. 5A to 5D are a front view, a right-side view, a cross-sectional view taken along arrows Y-Y, and a perspective view of the torque detection sensor.

FIGS. 6A to 6C are a front view, a right-side view, and a perspective view of a torque detection sensor according to another example of FIGS. 5A to 5D.

FIGS. 7A to 7C are a front view, a right-side view, and a perspective view of a torque detection sensor according to another example of FIGS. 5A to 5D.

FIGS. 8A to 8C are plan views of a core for a torque detection sensor and a plan view of the torque detection sensor according to another embodiment.

FIGS. 9A to 9C are a front view, a plan view, and a perspective view of an exploded toque detection sensor using the core of FIGS. 8A to 8C.

FIGS. 10A to 10C are explanation views showing an assembly configuration of a torque detection sensor according to another embodiment.

FIGS. 11A to 11C are a front view, a right-side view, and a perspective view of a torque detection sensor and an object to be detected according to another embodiment.

### DESCRIPTION OF EMBODIMENTS

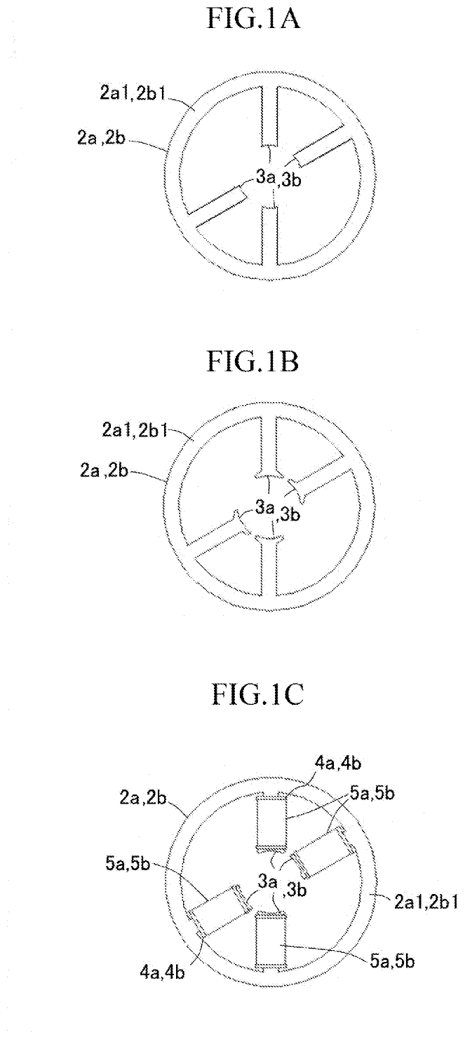

Hereinafter, a core for a torque detection sensor and a torque detection sensor according to an embodiment of the present invention will be explained with reference to the attached drawings. First, a schematic configuration of a torque detection sensor 1 will be explained with reference to FIGS. 1A to 1C to FIGS. 10A to 10C.

As an example of an object to be detected, a material with high inverse magnetostrictive effect is preferable. For example, there are permendur, Fe—Al (ALFE), Fe-Nix (permalloy), spherical graphite cast iron (JIS: FCD70), and the like as materials with high inverse magnetostrictive effect. The inverse magnetostrictive effect is a phenomenon in which magnetic characteristics are changed when stress is added to a magnetic body from the outside. When magnetic annealing is previously performed to the object to be detected according to need, the torque acting on the object to be detected can be suitably detected, which will be described in detail later. Even in a non-magnetic material, the torque can be detected by coating the material with a metal magnetic material by performing thermal spraying or by press-fitting a magnetic cylinder into a shaft. The object to be detected has a columnar shape, but the shape is not limited to this. An internal structure does not matter as long as the object to be detected has the columnar outer shape. For example, a cylindrical shape in which an inner diameter is fixed in an axial direction or a cylindrical shape in which the inner diameter differs according to positions in the axial direction may be adopted. Moreover, the object to be detected may be an object expected to rotate as well as an object not expected to rotate. Furthermore, the object to be detected may be a solid shaft material as well as a hollow shaft or the like.

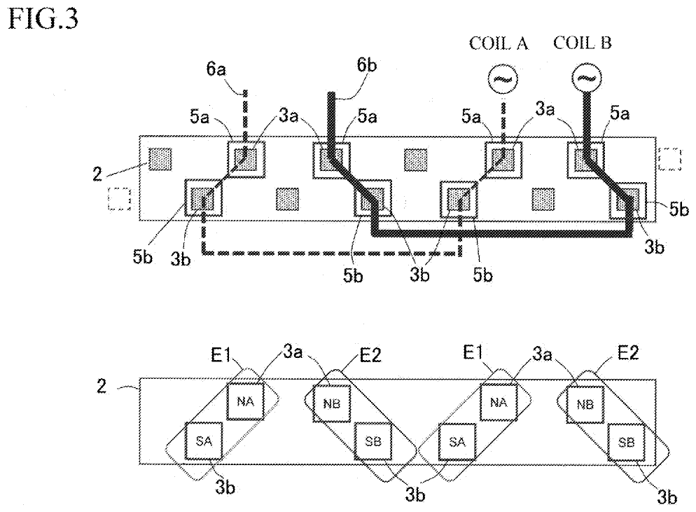

FIGS. 1A and 1B show an example of the core for the torque detection sensor. The core includes a first laminated core 2a in which first teeth 3a are provided to protrude at plural positions toward an inner side in a radial direction from an annular first core back 2a1 formed by laminating a plurality of magnetic sheet materials (electromagnetic steel sheets or the like), and a second laminated core 2b in which second teeth 3b are provided to protrude at plural positions toward the inner side in the radial direction from an annular core back 2b1 formed by laminating a plurality of magnetic sheet materials. As shown in FIG. 3, the first laminated core 2a and the second laminated core 2b are stacked so that the first teeth 3a and the second teeth 3b are provided in staggered arrangement in a circumferential direction.

Magnetic-flux action surfaces (end surfaces on the inner side in the radial direction) of the first teeth 3a and the second teeth 3a which face the object to be detected are formed to be the same width in FIG. 1A, but formed to be wider in width in FIG. 1B. Accordingly, a larger number of magnetic fluxes pass through the object to be detected from respective teeth, which improves detection sensitivity.

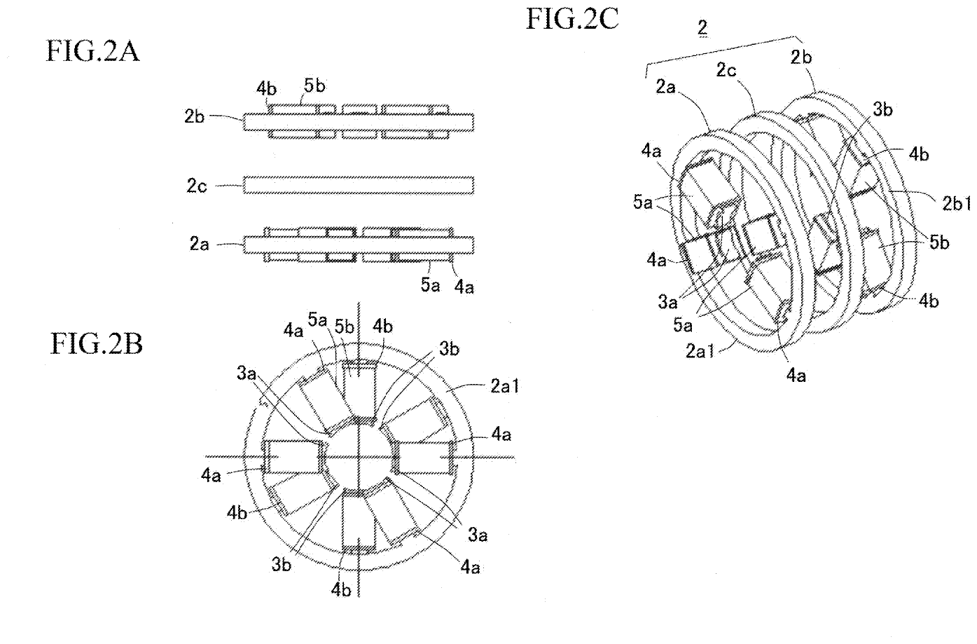

As shown in FIG. 2A, the first laminated core 2a and the second laminated core 2b may be stacked through an annular intermediate core 2c formed of a magnetic material integrated by caulking, adhesion, or a combination of them. According to the above, a larger number of coils 5 can be wound around the first teeth 3a and the second teeth 3b; therefore, an amount of magnetic fluxes acting on the object to be detected is increased to thereby improve detection sensitivity.

As shown in FIG. 1C, four first teeth 3a in total are provided to protrude in the first laminated core 2a with a predetermined phase difference in the circumferential direction at opposite positions toward the inner side in the radial direction. In the second laminated core 2b, four second teeth 2b in total are provided to protrude with a predetermined phase difference in the circumferential direction at opposite positions toward the inner side in the radial direction. As shown in FIGS. 2B and 2C, the first laminated core 2a and the second laminated core 2b are stacked through the intermediate core 2c so that the first teeth 3a and the second teeth 3b have different phases by 45 degrees in the circumferential direction. Accordingly, the first teeth 3a and the second teeth 3b are provided to protrude on an inner peripheral surface of a core 2 in staggered arrangement in the circumferential direction as shown in a developed view of the core 2 in FIG. 3. The intermediate core 2c is not provided with teeth protruding toward the inner side in the radial direction. The intermediate core 2c can be either a laminated core formed by laminating plural magnetic sheet materials or a block-shaped core. The core may be manufactured by using a sintered body, metal powder injection molding, and a green compact. A component formed by stacking plural cores 2a to 2c is written merely as the core 2 in FIG. 3.

For example, cores formed by laminating and pressing electromagnetic steel sheets are used as the first laminated core 2a having the first teeth 3a, the second laminated core 2b having the second teeth 3b, and the intermediate core 2c in the embodiment.

As shown in FIG. 1C, the plural first teeth 3a, four teeth in total, are provided to protrude in the annular first core back 2a1 with a predetermined phase difference in the circumferential direction at opposite positions toward the inner side in the radial direction in the first laminated core 2a. Cylindrical first insulators 4a made of insulating resin are fitted to the respective first teeth 3a, and first coils 5a are wound therearound.

As shown in FIG. 2B, the plural second teeth 3b, four teeth in total, are provided to protrude in the annular second core back 2b1 with a predetermined phase difference in the circumferential direction at opposite positions toward the inner side in the radial direction in the second laminated core 2b in the same manner as the first laminated core 2a. Cylindrical second insulators 4b made of insulating resin are fitted to the respective second teeth 3b, and second coils 5b are wound therearound.

As shown in FIGS. 2A and 2C, the annular intermediate core 2c is provided between the first laminated core 2a and the second laminated core 2b. The intermediate core 2c doubles as a spacer for securing a space where the first coils 5a and the second coils 5b are wound around the first teeth 3a and the second teeth 3b between the first laminated core 2a and the second laminated core 2b, and magnetic paths generated between the first laminated core 2a and the second laminated core 2b.

FIG. 3 shows a developed view of the core 2, an explanatory view showing an example of energizing circuits, and an explanation view for magnetic paths formed between teeth. Winding directions of the first coils 5a wound around the first teeth 3a and the second coils 5b wound around the second teeth 3b are opposite. The core 2 has a plurality of energizing circuits in which the first coils 5a and the second coils 5 are connected in series. Specifically, a first energizing circuit 6a (a broken line in an upper stage of FIG. 3) performs energization from the first coil 5a wound around the first tooth 3a to the second coil 5b wound around the second tooth 3b having a phase difference of +45 degrees in the circumferential direction, and performs energization from the second coil 5b wound around another second tooth 3b wired in the circumferential direction to the first coil 5a wound around another first tooth 3a having the phase difference of +45 degrees. More precisely, tip portions of the first teeth 3a facing the object to be detected and tip portions of the second teeth 3b facing the object to be detected are stacked through the intermediated core 2c so that the phase differs by +45 degrees in the circumferential direction. According to the energization to the first energizing circuit 6a (the broken line in the upper stage of FIG. 3), a plurality of magnetic paths (a lower stage of FIG. 3) having an inclination of +45 degrees with respect to an axial center direction are formed between the first teeth 3a and the second teeth 3b through the object to be detected.

A second energizing circuit 6b (a solid line in the upper stage of FIG. 3) performs energization from the first coil 5a wound around the first tooth 3a to the second coil 5b wound around the second tooth 3b having a phase difference of −45 degrees, and performs energization from the second coil 5b wound around another second tooth 3b wired in the circumferential direction to the first coil 5a wound around another first tooth 3a having the phase difference of −45 degrees. More precisely, tip portions of the first teeth 3a facing the object to be detected and tip portions of the second teeth 3b facing the object to be detected are stacked through the intermediated core 2c so that the phase differs by −45 degrees in the circumferential direction. According to the energization to the second energizing circuit 6b (the solid line in the upper stage of FIG. 3), a plurality of magnetic paths (the lower stage of FIG. 3) having an inclination of −45 degrees with respect to the axial center direction are respectively formed between the first teeth 3a and the second teeth 3b through the object to be detected. When the coils forming the first energizing circuit 6a are coils A and the coils forming the second energizing circuit 6b are coils B, NA in the drawing denotes teeth exited to N-pole by the coils A, SA denotes teeth excited to S-pole by the coils A. Similarly, NB in the drawing denotes teeth excited to N-pole by the coils B and SB denotes teeth exited to S-pole by the coils B. More precisely, tip portions of teeth facing an object to be detected S are excited to N-pole or S-pole. Whether being excited to N-pole or excited to S-pole can be determined by inverting the direction in which the coils A and the coils B (the first coils 5a and the second coils 5b) are wound.

A long frame E1 surrounding NA and SA, and a long frame E2 surrounding NB and SB shown in the lower stage of FIG. 3 represent inclinations of magnetic paths with respect to the axial center direction (a vertical direction in the drawing) in the magnetic paths formed between the first teeth 3a and the second teeth 3b. Note that teeth around which coils are not wound may exist in the first teeth 3a and the second teeth 3b provided in staggered arrangement.

As the torque detection sensor 1 described above, a self-excitation torque detection sensor is used, which measures variation of magnetic permeability by variation of coil impedance in magnetic circuits formed between teeth 3 and the object to be detected S by energizing the coils 5 wound around the teeth 3 facing the object to be detected S at plural positions. It is not always necessary that the winding directions of the first coils 5a wound around the first teeth 3a and the second coils 5b wound around the second teeth 3b are opposite, but the winding directions of the first coils 5a and the second coils 5b may be the same.

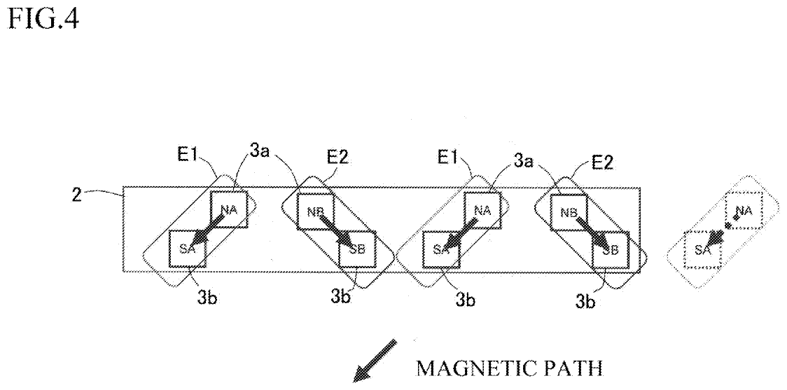

FIG. 4 is an explanatory view for the magnetic paths formed between the first teeth 3a and the second teeth 3b. A plurality of magnetic paths in which the first teeth 3a are excited to N-poles and the second teeth 3b are excited to S-poles are shown. The long frame E1 surrounding NA and SA represents an inclination (+45 degrees) of the magnetic paths with respect to the axial center direction (the vertical direction in FIG. 4) at the time of energizing the first energizing circuit 6a. The long frame E2 surrounding NB and SB represents an inclination (−45 degrees) of the magnetic paths with respect to the axial center direction (the vertical direction in FIG. 4) at the time of energizing the second energizing circuit 6b. The magnetic paths inclined to +45 degrees and the magnetic paths inclined to −45 degrees are formed alternately in the circumferential direction of the core (see the long frames E1, E2).

In this case, magnetic poles of the first teeth 3a adjacent in the circumferential direction have the same polarity (N-pole) and magnetic poles of the second teeth 3b adjacent in the circumferential direction also have the same polarity (S-pole); therefore, only magnetic-path components (±45 degrees) necessary for torque detection are formed, which can realize the torque detection efficiently.

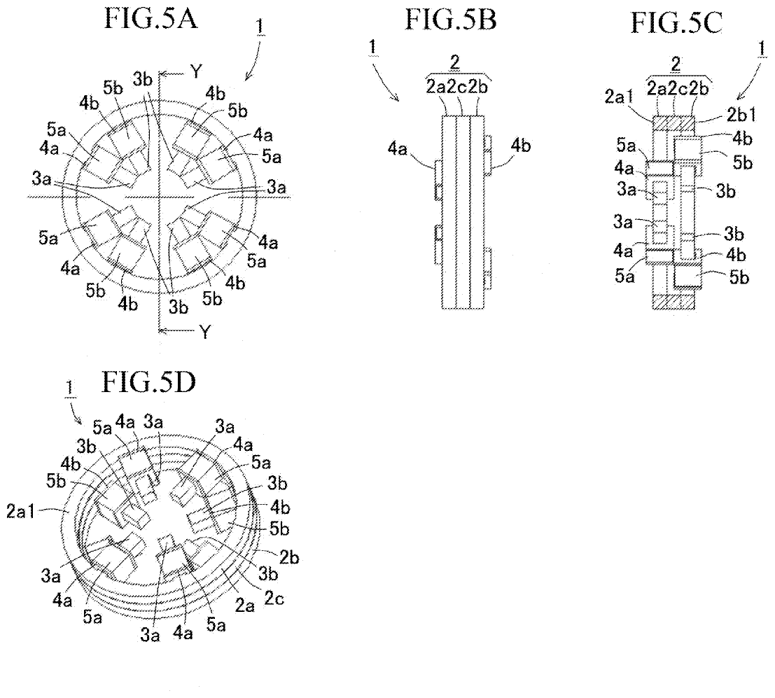

Here, configuration examples of the torque detection sensor 1 will be explained with reference to FIGS. 5A to 5D to FIGS. 10A to 10C. In FIGS. 5A to 5D, the core 2 is formed so that the annular first laminated core 2a, intermediate core 2c, and second laminated core 2b are integrally stacked. In the first laminated core 2a, four first teeth 3a in total are provided to protrude in the annular core back 2a1 with a predetermined phase difference in the circumferential direction at opposite positions toward the inner side of the radial direction. In the second laminated core 2b, four second teeth 3b in total are provided to protrude in the annular second core back 2b1 with a predetermined phase difference in the circumferential direction at opposite positions toward the inner side of the radial direction.

As shown in FIGS. 5A and 5D, the first laminated core 2a and the second laminated core 2b are stacked through the intermediate core 2c, and four pairs of the first teeth 3a and the second teeth 3b are provided so as to be stacked with a phase difference of 45 degrees in the circumferential direction. Moreover, when the intermediate core 2c is provided between the first teeth 3a and the second teeth 3b as shown in FIGS. 5B and 5C, a space for winding can be provided and the number of turns of the first coils 5a to be wound around the first teeth 3a and the second coils 5b to be wound around the second teeth 3b can be increased, which generates more magnetic fluxes and improves detection sensitivity.

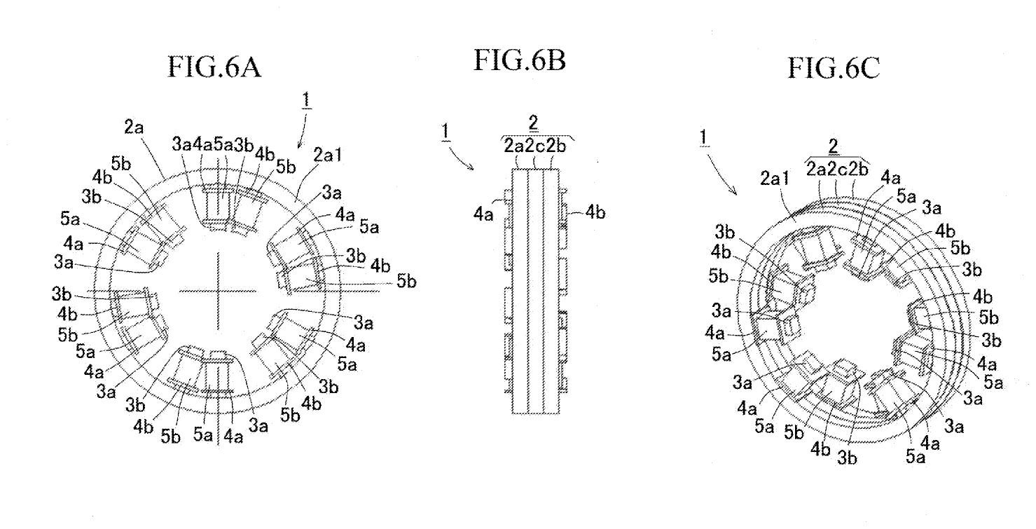

A configuration of the torque detection sensor 1 shown in FIGS. 6A to 6C is similar to the configuration of FIGS. 5A to 5D, but differs from that in the number of the first teeth 3a provided in the first laminated core 2a and the number of the second teeth 3b provided in the second laminated core 2b. In the first laminated core 2a, the first teeth 3a are provided to protrude in the annular first core back 2a1 at six places in the circumferential direction with a phase difference of 60 degrees in the circumferential direction at opposite positions toward the inner side in the radial direction. In the second laminated core 2b, the second teeth 3b are provided to protrude in the annular core back 2b1 (not shown) at six places in the circumferential direction with the phase difference of 60 degrees in the circumferential direction at opposite positions toward the inner side in the radial direction. The first laminated core 2a and the second laminated core 2b are stacked through the intermediate core 2c, and six pairs of the first teeth 3a and the second teeth 3b are provided so as to be stacked with a phase difference of 45 degrees in the circumferential direction.

As described above, the number of the first teeth 3a and the second teeth 3b provided to protrude in staggered arrangement in the circumferential direction in the first laminated core 2a and the second laminated core 2b is increased, thereby detecting torque variation acting on the object to be detected more delicately.

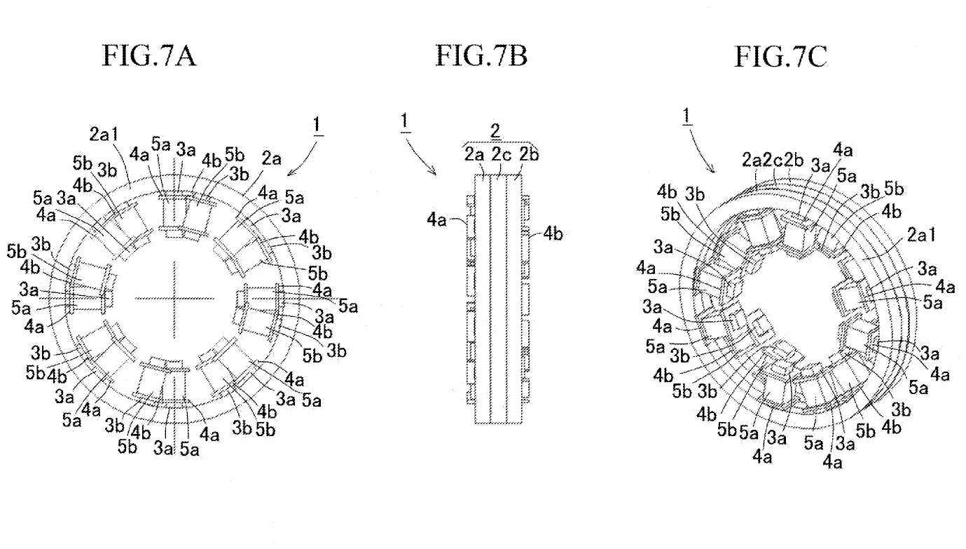

A configuration of the torque detection sensor 1 shown in FIGS. 7A to 7C is similar to the configurations of FIGS. 5A to 5D and FIGS. 6A to 6C, but differs from those in the number of the first teeth 3a provided in the first laminated core 2a and the number of the second teeth 3b provided in the second laminated core 2b. In the first laminated core 2a, the first teeth 3a are provided to protrude in the annular first core back 2a1 at eight places in the circumferential direction with the phase difference of 45 degrees in the circumferential direction at opposite positions toward the inner side in the radial direction. In the second laminated core 2b, the second teeth 3b are provided to protrude in the annular core back 2b1 (not shown) at eight places in the circumferential direction with the phase difference of 45 degrees in the circumferential direction at opposite positions toward the inner side in the radial direction. The first laminated core 2a and the second laminated core 2b are stacked through the intermediate core 2c, and eight pairs of the first teeth 3a and the second teeth 3b are provided so as to be stacked with the phase difference of 45 degrees in the circumferential direction.

As described above, the number of the first teeth 3a and the second teeth 3b provided to protrude in staggered arrangement in the circumferential direction in the first laminated core 2a and the second laminated core 2b is increased, thereby detecting torque variation acting on the object to be detected more delicately.

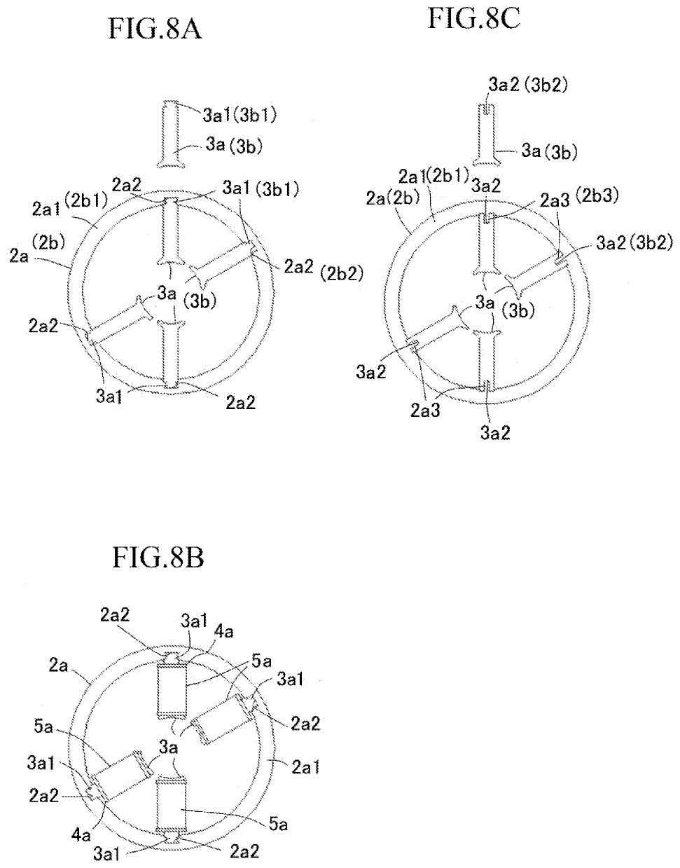

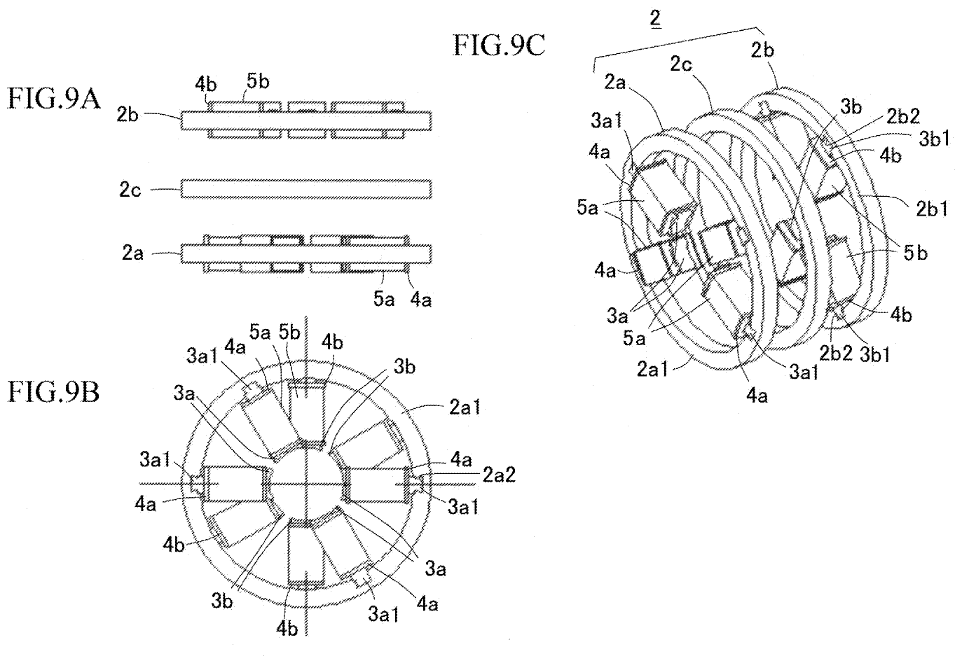

FIGS. 8A to 8C and FIGS. 9A to 9C show other configurations of the core for the torque detection sensor.

The configurations differ from the cores for the torque detection sensor of FIGS. 5A to 5D to FIGS. 7A to 7C in a point that the annular first core back 2a1 is not integrally formed with the first teeth 3a and the annular second core back 2b1 is not integrally formed with the second teeth 3b.

As shown in FIGS. 9A to 9C, four first teeth 3a in total are provided to protrude in the annular first core back 2a1 with a predetermined phase difference in the circumferential direction at opposite positions toward the inner side in the radial direction in the first laminated core 2a. Four second teeth 3b in total are provided to protrude in the annular second core back 2b1 with a predetermined phase difference in the circumferential direction at opposite positions toward the inner side in the radial direction. The configuration is the same in points that the first laminated core 2a and the second laminated core 2b are stacked through the intermediate core 2c and that the first teeth 3a and the second teeth 3b are provided so as to be stacked with the phase difference of 45 degrees in the circumferential direction.

As shown in FIGS. 8A and 8B, the first teeth 3a are assembled so that engaging portions 3a1 provided at outer end portions of the first teeth 3a are fitted in the axial center direction into dovetail grooves 2a2 provided on an inner peripheral surface of the first core back 2a1. In each of the first teeth 3a, the first insulator 4a is fitted in a state of being removed from the first core back 2a1, and the coil 5a is wound around the first insulator 4a. This is assembled so that the engaging portion 3a1 is fitted in the axial center direction into the dovetail groove 2a2 formed in the first core back 2a1 of the first laminated core 2a. As for an assembly structure of the second teeth 3b with respect to the second core back 2b1 of the second laminated core 2b, the second teeth 3b are assembled so that engaging portions 3b1 are fitted in the axial center direction into dovetail grooves 2b2 in the same manner as the first teeth 3a (see FIGS. 9A to 9C).

As shown in FIG. 8C, it is also preferable that projections 2a3 are formed on the inner peripheral surface of the first core back 2a1 and recesses 3a2 are provided at outer end portions in the radial direction of the first teeth 3a and that the projections 2a3 and the recesses 3a2 are recess-projection fitted in the axial center direction to thereby assemble the first teeth 3a to the first core back 2a1 toward the inner side of the radial direction. The assembly of the second teeth 3b with respect to the second core back 2b1 is also executed by recess-projection fitting projections 2b3 into recesses 3b2 in the axial center direction in the same manner as the first teeth 3a. In this core state, the degree of freedom in assembling the first teeth 3a to the first core back 2a1 and assembling the second teeth 3b to the second core back 2b1 is high; therefore, assimilability is good.

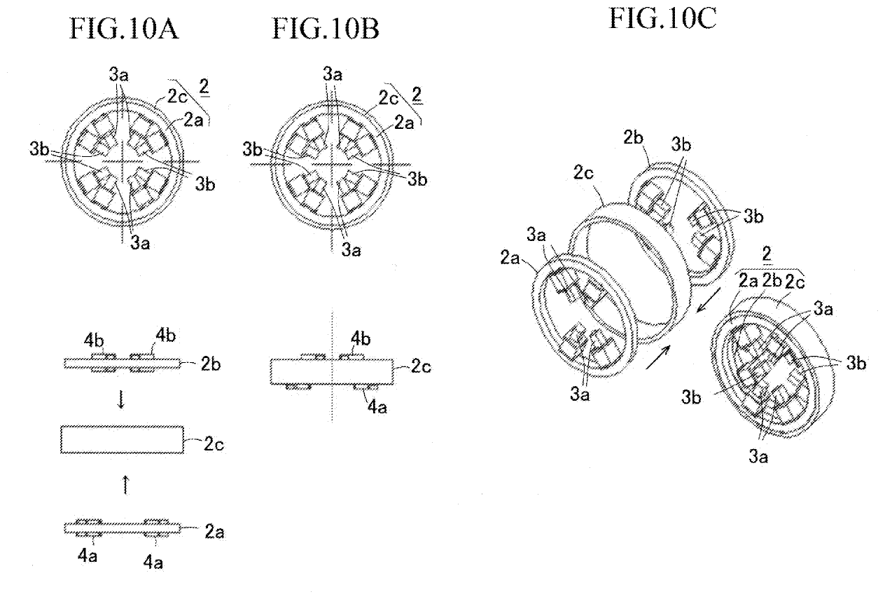

FIGS. 10A to 10C are explanatory views showing an assembly configuration of the torque detection sensor according to another embodiment.

In the above embodiments, the annular first laminated core 2a, intermediate core 2c, and second laminated core 2b which have the same diameter are stacked in the axial center direction to be integrally assembled as the core 2 in the same manner as in FIGS. 2A to 2C; however, it is also preferable that an outer diameter of the intermediate core 2c is larger than those of the first laminated core 2a and the second laminated core 2b and that these cores are concentrically fitted from both end openings of the intermediate core 2c.

FIG. 10A shows a plan view and a front exploded view of an opening end showing a state before inserting the first laminated core 2a and the second laminated core 2b into the intermediate core 2c. FIG. 10B shows a plan view and a front view of the opening end showing a state where the first laminated core 2a and the second laminated core 2b are fitted to the intermediate core 2c from both end openings. FIG. 10C is a perspective view showing states before and after inserting the first laminated core 2a the second laminated core 2b into the intermediate core 2c. As shown in FIG. 10C, the first laminated core 2a and the second laminated core 2b inserted from both end openings of the intermediate core 2c may be fitted with a predetermined gap. As the intermediate core 2c is also a magnetic body, magnetic circuits are formed between the first teeth 3a and the second teeth 3b phases of which differ by 45 degrees through the intermediate core 2c.

As explained above, the first laminated core 2a in which the first teeth 3a are provided in the annular first core back 2a1 and the second laminated core 2b in which the second teeth 3b are provided in the annular second core back 2b1 can be manufactured through manufacturing processes similar to a laminated core used for a stator core of the motor, and the first coils 5a and the second coils 5b wound around the first teeth 3a and the second teeth 3b can be wound by using a winding machine, as a result, the sensor can be reduced in size in the radial direction and can be mass produced at low cost. For example, the torque detection sensor in related art of Japanese Patent NO. 6483778 has ø35 mm, and 25 mm as a length in the axial center direction. The torque detection sensor 1 according to the present invention can be reduced in size, having ø16 mm, and 10 mm as a length in the axial center direction.

It is possible to provide a small-sized torque detection sensor capable of detecting compressive stress and tensile stress generated over the entire periphery of the object to be detected without reducing detection sensitivity by using the above.

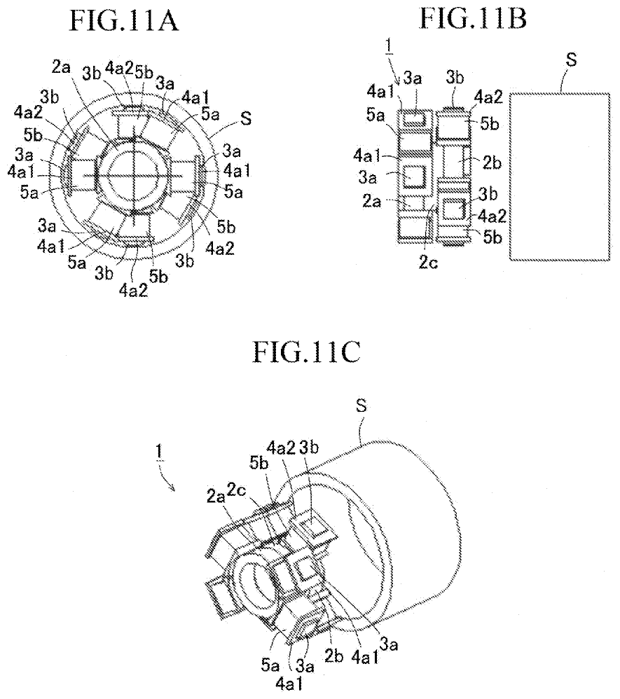

FIGS. 11A to 11C are a front view, a right-side view, and a perspective view of a core for a torque detection sensor, the torque detection sensor, and an object to be detected according to another embodiment. In a case of detecting the torque of a hollow shaft, the core for the torque detection sensor is formed so that the first teeth 3a and the second teeth 3b provided in the annular first core back 2a1 and second core back 2b1 are formed toward an outer side in the radial direction. In FIGS. 11A to 11C, the core 2 is formed so that the annular first core 2a, intermediate core 2c, and second core 2b are integrally stacked. In the first core 2a, for example, four first teeth 3a in total are provided to protrude in the annular core back 2a1 with a predetermined phase difference in the circumferential direction at opposite positions toward the outer side in the radial direction. In the second core 2b, for example, four second teeth 3b in total are provided to protrude in the annular core back 2b1 with a predetermined phase difference in the circumferential direction at opposite positions toward the outer side in the radial direction. The first coils 5a are wound around the first teeth 3a through first insulators 4a1, and the second coils 5b are wound around the second teeth 3b through second insulators 4a2. The first core 2a and the second core 2b are stacked through the intermediate core 2c, and for example, four pairs of the first teeth 3a and the second teeth 3b are provided so as to be stacked with a phase difference of 45 degrees in the circumferential direction.

The above-described torque detection sensor 1 is concentrically inserted into a hollow hole of the object to be detected S (hollow shaft), and the first teeth 3a and the second teeth 3b are assembled so as to face an inner peripheral surface of the object to be detected S as shown in FIGS. 11B and 11C. Accordingly, magnetic circuits including the object to be detected S are formed between the first teeth 3a and the second teeth 3b provided in the staggered arrangement as shown in FIG. 11A, and torque variation can be detected from magnetic path components of ±45 degrees.

As described above, the sensor can detect torque variation of not only the solid shaft but also the hollow shaft as the object to be detected S, which improves versatility.

As explained above, the torque detection sensor 1 according to the embodiment can detect the torque in either case of the solid shaft or the hollow shaft.

What is claimed is:

1. A core for a torque detection sensor that measures variation of magnetic permeability by variation of coil impedance in magnetic circuits formed between a core and an object to be detected by energizing coils wound around teeth provided to protrude from the annular core provided around the object to be detected at plural places, comprising:
a first laminated core in which first teeth are provided to protrude in a radial direction at plural places from an annular first core back formed by laminating a plurality of magnetic sheet materials; and
a second laminated core in which second teeth are provided to protrude in the radial direction at plural places from an annular second core back formed by laminating a plurality of magnetic sheet materials,
wherein the first laminated core and the second laminated core are stacked so that the first teeth and the second teeth are in staggered arrangement in a circumferential direction.

2. The core for the torque detection sensor according to claim 1,
wherein the first teeth and the second teeth are provided in staggered arrangement with a phase difference having an inclination of 45 degrees with respect to the circumferential direction.

3. The core for the torque detection sensor according to claim 1,
wherein magnetic-flux action surfaces of the first teeth and the second teeth which face the object to be detected are formed to be wider in width.

4. The core for the torque detection sensor according to claim 1,
wherein the first laminated core and the second laminated core are stacked through an annular intermediate core formed of a magnetic material.

5. The core for the torque detection sensor according to claim 1,
wherein an outer diameter of the annular intermediate core formed of the magnetic material is larger than those of the first laminated core and the second laminated core, and the first laminated core and the second laminated core are concentrically fitted from both end openings of the intermediate core to be integrally assembled.

6. The core for the torque detection sensor according to claim 1,
wherein the first teeth are assembled so that engaging portions are fitted in an axial center direction into dovetail grooves provided on a peripheral surface of the first core back, and
the second teeth are assembled so that engaging portions are fitted in the axial center direction into dovetail grooves provided on a peripheral surface of the second core back.

7. The core for the torque detection sensor according to claim 1,
wherein the first teeth are assembled so that projections provided on a peripheral surface of the first core back are fitted in an axial center direction into recesses provided at end portions in the radial direction, and
the second teeth are assembled so that projections provided on a peripheral surface of the second core back are fitted in the axial center direction into recesses provided at end portions in the radial direction.

8. A torque detection sensor comprising:
the core for the torque detection sensor according to claim 1; and
a plurality of energizing circuits in which first coils and second coils which are wound in different directions around the first teeth and the second teeth are connected in series.

9. The torque detection sensor according to claim 8,
wherein the sensor is a self-excitation sensor that measures variation of magnetic permeability by variation of coil impedance in magnetic circuits formed between a core and an object to be detected by energizing the first coils wound around the first teeth and the second coils wound around the second teeth provided to protrude in the core for the torque detection sensor in staggered arrangement.
